(19) United States
(12) Patent Application Publication
(10) Pub. No.: US 2018/0075240 A1
(43) Pub. Date: Mar. 15, 2018

(54) METHOD AND DEVICE FOR DETECTING A SUSPICIOUS PROCESS BY ANALYZING DATA FLOW CHARACTERISTICS OF A COMPUTING DEVICE

(71) Applicant: Alibaba Group Holding Limited, Grand Cayman (KY)

(72) Inventor: Yanjun CHEN, Hangzhou (CN)

(21) Appl. No.: 15/559,176

(22) PCT Filed: Mar. 14, 2016
(86) PCT No.: PCT/CN2016/076228

§ 371 Date: Sep. 18, 2017

(30) Foreign Application Priority Data
Mar. 20, 2015 (CN) 201510124614.5

(51) Int. Cl. G06F 21/56; G06F 21/62

(52) U.S. Cl. CPC G06F 21/566; G06Q 30/0601; G06F 21/6245

(57) ABSTRACT

Disclosed are methods and devices for detecting a suspicious process. Test values of data flow direction characteristics of a to-be-detected host and sample values of the data flow direction characteristics corresponding to the to-be-detected host in a data flow direction library are acquired, wherein the data flow direction characteristics comprise at least one of a process list and a network egress characteristic, and a data source characteristic. It is then determined that a suspicious process is detected when a test value of the process list is different from a sample value of the process list and/or a test value of the network egress characteristic is different from a sample value of the network egress characteristic in the case that a test value of the data source characteristic is the same as a sample value of the data source characteristic. It can be seen that the disclosed methods and devices for detecting a suspicious process according detect a suspicious process based on the data flow direction characteristics rather than the attack behaviors of applications. Moreover, because data flow direction characteristics change whenever data theft occurs, the methods and devices can accurately detect a suspicious process in which data might be stolen.

This application claims priority to Chinese Patent Application No. 201510124614.5, filed on Mar. 20, 2015 and entitled “METHOD AND DEVICE FOR DETECTING SUSPICIOUS PROCESS,” and PCT Application No. PCT/CN2016/076228, titled “METHOD AND DEVICE FOR DETECTING SUSPICIOUS PROCESS” filed on Mar. 14, 2016, the disclosure of each hereby incorporated by reference in their entirety.

### BACKGROUND

### Technical Field

The disclosed embodiments relate to the field of computers, and in particular, to methods and devices for detecting a suspicious process by analyzing data flow characteristics of a computing device.

### Description of the Related Art

Data security is one of the core issues that cloud computing and open platforms face. An e-commerce cloud is used here as an example. An independent software vendor (ISV) software system is deployed in the e-commerce cloud environment, and after obtaining the subscription authorization from TMALL and TAOBAO merchants, the ISV can access sensitive data, for example, orders and customer relationships of the merchants on TMALL and TAOBAO through TAOBAO Open Platform (TOP). Any software or cloud resource management vulnerability of the ISV can be exploited, and a backdoor can be deployed in a cloud host or application. Sensitive data may be read, copied, or transmitted illegally, leading to the leakage of a large volume of data.

Traditional virus detection methods usually employ protection policies to defend against attack behaviors of virus programs on systems. Backdoor programs stealing data in cloud hosts or applications, however, generally aim at data acquisition without behavior characteristics of actively attacking systems.

Therefore, the traditional virus detection techniques cannot accurately detect a suspicious process in which data might be stolen.

### BRIEF SUMMARY

The disclosure provides methods and devices for detecting suspicious processes, solving the problem that a suspicious process in which data might be stolen cannot be detected accurately using current techniques.

In order to achieve this objective, the disclosure provides the following technical solutions.

The disclosure describes a method for detecting a suspicious process, comprising: acquiring test values of data flow direction characteristics of a to-be-detected host, and sample values of the data flow direction characteristics corresponding to the to-be-detected host in a data flow direction library, wherein the data flow direction characteristics comprise at least one of a process list and a network egress characteristic, and a data source characteristic; the data source characteristic is used to indicate a data source of a preset type of data flowing into the to-be-detected host; the process list comprises processes, ranked in chronological order, using data flowing out of the data source; and the network egress characteristic is used to, after the data flowing out of the data source is used by the processes in the process list, indicate an egress for the data flowing out of the data source to flow out of the to-be-detected host; and determining that a suspicious process is detected when a test value of the process list is different from a sample value of the process list and/or a test value of the network egress characteristic is different from a sample value of the network egress characteristic in the case that a test value of the data source characteristic is the same as a sample value of the data source characteristic.

In one embodiment, establishing the data flow direction library comprises respectively establishing data flow direction characteristics for each data source in the following manner: determining a network event relevant to one of the data source characteristics from a pre-acquired network event table of the to-be-detected host; and sequentially obtaining processes using data of the data source and a second network egress through which data of the second data source flows out by using a process number and a timestamp of the network event as search conditions and by associating the network event table with a process event table of the to-be-detected host and a file read/write event table of the to-be-detected host.

In one embodiment, the method further comprises: acquiring test values of behavior characteristics of each application from the to-be-detected host and sample values of the behavior characteristics of the to-be-detected host from an application behavior library, wherein the behavior characteristics comprise at least one of the following an application level, an access frequency of the application to the data source of the preset type of data, an external connection frequency of the application, an external connection destination address of the application, an external connection port of the application, a user running the application, process command parameters of the application, a running frequency of the application, and a running duration of the application; and determining that a suspicious process is detected if a difference between a test value of any of the behavior characteristics of an application and a sample value of the behavior characteristic of the application in the behavior characteristic library is not within a preset range.

In one embodiment, in the case that any of the behavior characteristics is multidimensional data, a method for determining a difference between a test value of the behavior characteristic and a sample value of the behavior characteristic in the behavior characteristic library comprises calculating a distance value between the test value of the behavior characteristic and the sample value of the behavior characteristic in the behavior characteristic library.

In one embodiment, establishing the application behavior library comprises acquiring behavior characteristics of each application from a network event table and process event table of the to-be-detected host that are pre-acquired, wherein the behavior characteristics comprise an application level, an access frequency of the application to the data source of the preset type of data, an external connection frequency of the application, an external connection destination address of the application, an external connection port of the application, a user running the application, process command parameters of the application, a running frequency of the application, and a running duration of the application.

In one embodiment, the method further comprises determining the suspicious process from processes of the to-be-detected host according to preset process risk rules, wherein the process risk rules comprise: the to-be-detected host initiates a network connection to itself and a target port of the connection is a remote login port.

The disclosure further describes a device for detecting a suspicious process, comprising: a first acquisition module, configured to acquire test values of data flow direction characteristics of a to-be-detected host, and sample values of the data flow direction characteristics corresponding to the to-be-detected host in a data flow direction library, wherein the data flow direction characteristics comprise at least one of a process list and a network egress characteristic, and a data source characteristic; the data source characteristic is used to indicate a data source of a preset type of data flowing into the to-be-detected host; the process list comprises processes, ranked in chronological order, using data flowing out of the data source; and the network egress characteristic is used to, after the data flowing out of the data source is used by the processes in the process list, indicate an egress for the data flowing out of the data source to flow out of the to-be-detected host; and a first determining module, configured to determine that a suspicious process is detected when a test value of the process list is different from a sample value of the process list and/or a test value of the network egress characteristic is different from a sample value of the network egress characteristic in the case that a test value of the data source characteristic is the same as a sample value of the data source characteristic.

In one embodiment, the device further comprises: a data flow direction library establishing module, configured to respectively establish data flow direction characteristics for each data source in the following manner: determining a network event relevant to one of the data source characteristics from a pre-acquired network event table of the to-be-detected host; and sequentially obtaining processes using data of the data source and a second network egress through which data of the second data source flows out by using a process number and a timestamp of the network event as search conditions and by associating the network event table with a process event table of the to-be-detected host and a file read/write event table of the to-be-detected host.

In one embodiment, the device further comprises: a second acquisition module, configured to acquire test values of behavior characteristics of each application from the to-be-detected host and sample values of the behavior characteristics of the to-be-detected host from an application behavior library, wherein the behavior characteristics comprise at least one of the following: an application level, an access frequency of the application to the data source of the preset type of data, an external connection frequency of the application, an external connection destination address of the application, an external connection port of the application, a user running the application, process command parameters of the application, a running frequency of the application, and a running duration of the application; and a second determining module, configured to determine that a suspicious process is detected if a difference between a test value of any of the behavior characteristics of an application and a sample value of the behavior characteristic of the application in the behavior characteristic library is not within a preset range.

In one embodiment, the specific process that the second determining module is configured to, in the case that any of the behavior characteristics is multidimensional data, determine a difference between a test value of the behavior characteristic and a sample value of the behavior characteristic in the behavior characteristic library comprises the second determining module is specifically configured to calculate a distance value between the test value of the behavior characteristic and the sample value of the behavior characteristic in the behavior characteristic library.

In one embodiment, the device further comprises an application behavior library establishing module, configured to acquire behavior characteristics of each application from a network event table and process event table of the to-be-detected host that are pre-acquired, wherein the behavior characteristics comprise an application level, an access frequency of the application to the data source of the preset type of data, an external connection frequency of the application, an external connection destination address of the application, an external connection port of the application, a user running the application, process command parameters of the application, a running frequency of the application, and a running duration of the application.

In one embodiment, the device further comprises a third determining module, configured to determine the suspicious process from processes of the to-be-detected host according to preset process risk rules, wherein the process risk rules comprise: the to-be-detected host initiates a network connection to itself and a target port of the connection is a remote login port.

As compared with current techniques, the disclosed embodiments have the following beneficial effects.

In the disclosed embodiments for detecting a suspicious process, test values of data flow direction characteristics of a to-be-detected host and sample values of the data flow direction characteristics corresponding to the to-be-detected host in a data flow direction library are acquired, wherein the data flow direction characteristics comprise a data source characteristic, a process list, and a network egress characteristic; and it is determined that a suspicious process is detected when a test value of the process list is different from a sample value of the process list or a test value of the network egress characteristic is different from a sample value of the network egress characteristic in the case that a test value of the data source characteristic is the same as a sample value of the data source characteristic. The methods and devices for detecting a suspicious process disclosed herein detect a suspicious process based on the data flow direction characteristics rather than the attack behaviors of applications. Moreover, because data flow direction characteristics change whenever data theft occurs, the disclosed methods and devices can accurately detect a suspicious process in which data might be stolen.

Certainly, any product implementing the disclosed embodiments does not necessarily need to achieve all the above-described advantages at the same time.

### BRIEF DESCRIPTION OF THE DRAWINGS

In order to more clearly illustrate the technical solutions in the embodiments of the disclosure, the drawings which need to be used in the description of the embodiments will be introduced briefly below. The drawings described below are merely some embodiments of the disclosure, and those of ordinary skill in the art can also obtain other drawings according to these drawings without making creative efforts.

FIG. 1 is a flow diagram illustrating a method for detecting a suspicious process according to some embodiments of the disclosure.

FIG. 2 is a flow diagram illustrating a method for detecting a suspicious process according to some embodiments of the disclosure.

FIG. 3 is a flow diagram illustrating a method for establishing a data flow direction library and an application behavior library according to some embodiments of the disclosure.

FIG. 4 is a flow diagram illustrating a method for collecting event data in a preset time period by a collection client deployed on a to-be-detected host according to some embodiments of the disclosure.

FIG. 5 is a diagram illustrating data flow direction characteristics of one data source according to some embodiments of the disclosure.

FIG. 6 is a block diagram illustrating a device for detecting a suspicious process according to some embodiments of the disclosure.

FIG. 7 is a block diagram illustrating another device for detecting a suspicious process further according to some embodiments of the disclosure.

FIG. 8 is a block diagram illustrating a connection relationship between a device for detecting a suspicious process and a to-be-detected host according to some embodiments of the disclosure.

### DETAILED DESCRIPTION

Embodiments described herein illustrate methods and devices for detecting a suspicious process, which can be applied to the detection of a suspicious process taking place on a cloud host, making it possible to accurately detect a suspicious process in which data in the cloud host might be stolen.

The technical solutions in the disclosed embodiments will be described clearly and completely below with reference to the drawings in the illustrated embodiments. The disclosed embodiments are merely some, rather than all of the embodiments of the disclosure. On the basis of the embodiments, all other embodiments obtained by those of ordinary skill in the art without making creative efforts shall fall within the protection scope of the disclosure.

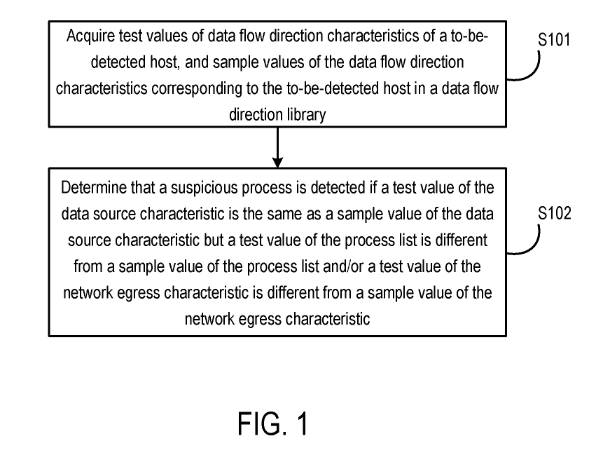

FIG. 1 is a flow diagram illustrating a method for detecting a suspicious process according to some embodiments of the disclosure.

S101: Acquire test values of data flow direction characteristics of a to-be-detected host (e.g., a cloud-hosted system or application), and sample values of the data flow direction characteristics corresponding to the to-be-detected host in a data flow direction library.

In one embodiment, the data flow direction characteristics may include: at least one of a process list and a network egress characteristic, and a data source characteristic. That is to say, the data flow direction characteristics include the data source characteristic; and in addition, the process list and the network egress characteristic may also be included; or either the process list or the network egress characteristic may be included. In the case that the data flow direction characteristics include the process list and the network egress characteristic, the detection accuracy is higher, the following embodiments are all described by using the following case as an example: data flow direction characteristics include the data source characteristic, the process list, and the network egress characteristic.

In one embodiment, the data source characteristic is used to indicate a data source of a preset type of data flowing into the to-be-detected host; the process list includes processes, ranked in chronological order, using data flowing out of the data source; and the network egress characteristic is used to, after the data flowing out of the data source is used by the processes in the process list, indicate an egress for the data flowing out of the data source to flow out of the to-be-detected host.

Both a test value and a sample value of the process list may be a name or number of a file included in the process list. If the test value and the sample value of the process list are different, it indicates that processes using data change; and the change may include an addition of processes or change of processes in chronological order.

Both a test value and a sample value of the data source characteristic may be an address or a port number of the data source; and both a test value and a sample value of the network egress characteristic may be an address or a port number of the network egress.

S102: Determine that a suspicious process is detected if a preset condition is met in the case that the test value of the data source characteristic is the same as the sample value of the data source characteristic. The preset condition includes at least any one of the following:

1. the test value of the process list is different from the sample value of the process list; and

2. the test value of the network egress characteristic is different from the sample value of the network egress characteristic.

Because a data thief needs to read data through a backdoor application or steal data by guiding the data flow, the aforementioned conditions are set by considering these two aspects in this embodiment, so as to fundamentally discover data thefts.

The suspicious process is a process corresponding to an abnormal characteristic. For example, with respect to a process list, a comparison between the test value and the sample value of the process list can be made. A process to which an additional name or number corresponds is a suspicious process. Regarding the network egress characteristic, when the test value is different from the sample value, then a process transmitting data externally from the to-be-detected host through the network egress is a suspicious process.

For example, the method according to the aforementioned embodiments can be utilized by an e-commerce platform. For the e-commerce platform, the preset type of data may be sensitive data (e.g., order information of customers). To prevent sensitive data in a cloud host from leakage, test values of data flow direction characteristics in the cloud host of the e-commerce platform are detected; and sample values of the data flow direction characteristics of the cloud host are acquired from a data flow direction library. In a situation that a test value and a sample value of a data source characteristic of the sensitive information are the same, but a test value and a sample value in a process list of the sensitive information are different (e.g., an additional process using the sensitive information exists), then the additional process may be a process involved in data theft. Therefore, it can be determined that a risk of data theft exists, which in turn indicates that a suspicious process is detected. Network operation and maintenance personnel can further determine whether the process is really a risk-involving process; and if so, corresponding measurements are to be taken.

It can be seen that as compared with existing virus detection techniques, the method according to the aforementioned embodiments uses the characteristics of data theft as a starting point; and data flow direction characteristics in a to-be-detected host are used as a basis for performing suspicious process detection. As a result, a suspicious process of data theft can be accurately discovered.

Based on the method according to the aforementioned embodiment, other steps may be further added to improve the accuracy of the suspicious process detection. In other embodiments, methods for detecting a suspicious process, when compared to the previous embodiments, are not only based on data flow direction characteristics.

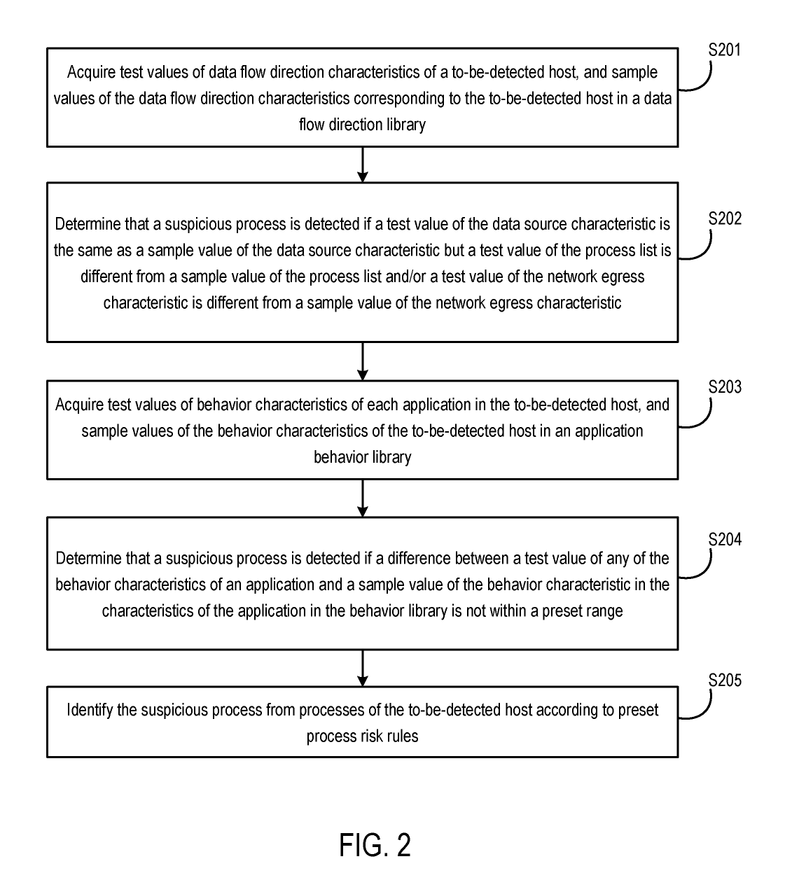

FIG. 2 is a flow diagram illustrating a method for detecting a suspicious process according to some embodiments of the disclosure.

S201: Acquire test values of data flow direction characteristics of a to-be-detected host, and sample values of the data flow direction characteristics corresponding to the to-be-detected host in a data flow direction library.

With respect to Step S201, reference may be made to the previous Figure (and, in particular, Step S101) for a description data flow direction characteristics, which is not repeated herein but is incorporated herein by reference in its entirety.

S202: Determine that a suspicious process is detected when a test value of the process list is different from a sample value of the process list and/or a test value of the network egress characteristic is different from a sample value of the network egress characteristic in the case that a test value of the data source characteristic is the same as a sample value of the data source characteristic.

S203: Acquire test values of behavior characteristics of each application in the to-be-detected host, and sample values of the behavior characteristics of the to-be-detected host in an application behavior library.

In one embodiment, the behavior characteristics are used to represent behaviors of each application in the to-be-detected host and may include at least one of the following: an application level, an access frequency of the application to the data source of the preset type of data, an external connection frequency of the application, an external connection destination address of the application, an external connection port of the application, a user running the application, process command parameters of the application, a running frequency of the application, and a running duration of the application.

In this embodiment, applications may be divided into four levels, which are: L1 programs directly accessing a data source or intermediate file and initiating external network connections; L2 programs accessing a data source or intermediate file but not having other network connections; L3 programs not accessing a data source or intermediate file but having active external connection behaviors; and IA programs not accessing a data source or intermediate file and not having active external connection behaviors.

S204: Determine that a suspicious process is detected if a difference between a test value of any of the behavior characteristics of an application and a sample value of the behavior characteristic in the characteristics of the application in the behavior library is not within a preset range.

In one embodiment, in the case that any of the behavior characteristics is multidimensional data, the method for determining a difference between a test value of the behavior characteristic and a sample value of the behavior characteristic in the behavior characteristic library may be calculating a distance value between the test value of the behavior characteristic and the sample value of the behavior characteristic in the behavior characteristic library. The distance value is the difference between the test value of the behavior characteristic and the sample value of the behavior characteristic in the behavior characteristic library; and the distance value may be a K-nearest neighbor distance value; in the case that any of the behavior characteristics is multidimensional data, a difference between a test value and a sample value may be calculated directly.

In this embodiment, the preset range may be set in advance; the wider the range, the higher the tolerance, which leads to a less strict condition for detecting a suspicious process. The narrower the range, the lower the tolerance, which leads to a more strict condition for detecting a suspicious process. The preset range may be set according to actual needs of a system.

For example, when a test value of an external connection frequency of a certain application is clearly greater than a sample value thereof in a cloud host, it indicates that this application may be stealing data; it is then determined that a suspicious process is detected; and the suspicious process is a process to which this application corresponds.

S205: Identify the suspicious process from processes of the to-be-detected host according to preset process risk rules.

The process risk rules may include: the to-be-detected host initiates a network connection to itself and a target port of the connection is a remote login port.

In this embodiment, the network maintenance personnel may obtain the process risk rules through previous knowledge.

The purpose of step S205 is to add some characteristics, which may lead to serious security incidents, into the process risk rules. Once these characteristics appear in the to-be-detected host, it can be determined straightforwardly that a suspicious process exists without the host having to performing a detection through data flow direction characteristics and behavior characteristics.

It can be seen from FIG. 2 that S201 and S202, S203 and S204, and S205 are three respective sub-processes of a suspicious process detection. It should be noted that the reference numerals representing the steps in this Figure are only used for illustration; and the execution order of these three sub-processes is not limited in actual application.

Optionally, after determining that a suspicious process is detected, this embodiment may further include: sending a warning signal and adding a number of the suspicious process into a suspicious process list. Network operations personnel can then review the suspicious process list and investigate the suspicious process thoroughly; and if it is confirmed that the process does not involve any risk, the network operation personnel then corrects the finding in the system. The corrected record will be added into the application behavior library or the data flow direction library of the host. If it is determined that a risk does exist, the network operation personnel can intuitively locates the risk-involving process or the mode with abnormal data flow pattern; an emergency measure is initiated to manage the risk.

The methods described in the above embodiments can be applied to a cloud host of an e-commerce platform and can detect a suspicious process of data theft from three aspects; and because no human-computer interaction behaviors exist on applications deployed on the cloud host, data circulation in the host and application behaviors in the host are relatively stable with evident characteristics. The aforementioned methods detect a suspicious process of data theft in a to-be-detected host from three aspects including data flow direction characteristics in the to-be-detected host, behavior characteristics, and process risk rules. The detection can then be performed from more diversified perspectives; and exceptions in data access behaviors can be observed in a more timely and accurate manner, which in turn locate a suspicious backdoor or program. Even if a backdoor program itself drastically changes, a data theft can be quickly observed as long as the data theft behavior exists.

It should be noted that in the aforementioned embodiments, test values may be collected from event records of the to-be-detected host in a first time period (for example, a certain day), whereas sample values may be generated according to data collected in event records of the to-be-detected host in a second time period (for example, one month).

A method for establishing a data flow direction library and an application behavior library will be described in detail below.

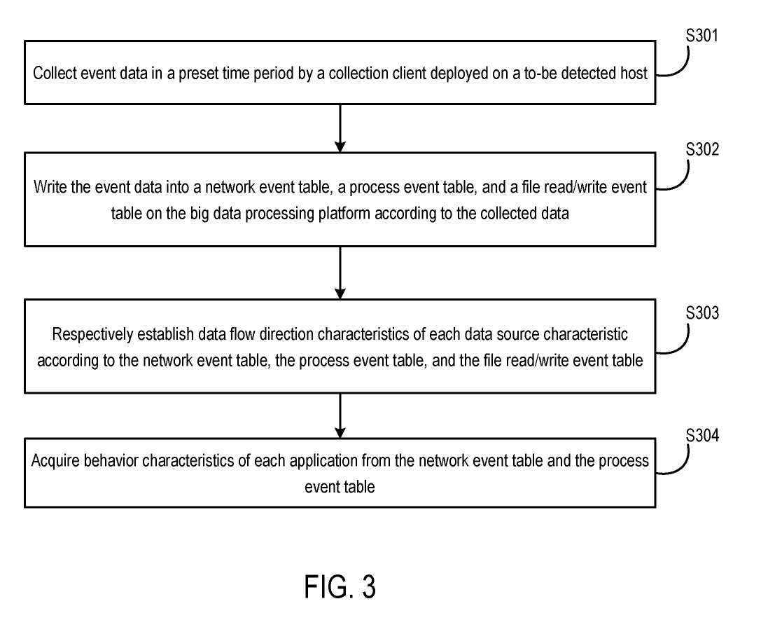

FIG. 3 is a flow diagram illustrating a method for establishing a data flow direction library and an application behavior library according to some embodiments of the disclosure.

S301: Collect event data in a preset time period (for example, one month) by a collection client deployed on a to-be detected host.

Events may specifically include network events, process events, and file read/write events.

Specifically, network event data may include an identifier or name of a process initiating or otherwise establishing a network connection, an initiation time, a source IP and port, and a destination IP and port. Process event data may include a number of a process, an event type (including start or stop), an active time, a process name, and command line parameters. File read/write event data may include a number of read/write operation record process on a file, a read/write type (including read or write), and an active time.

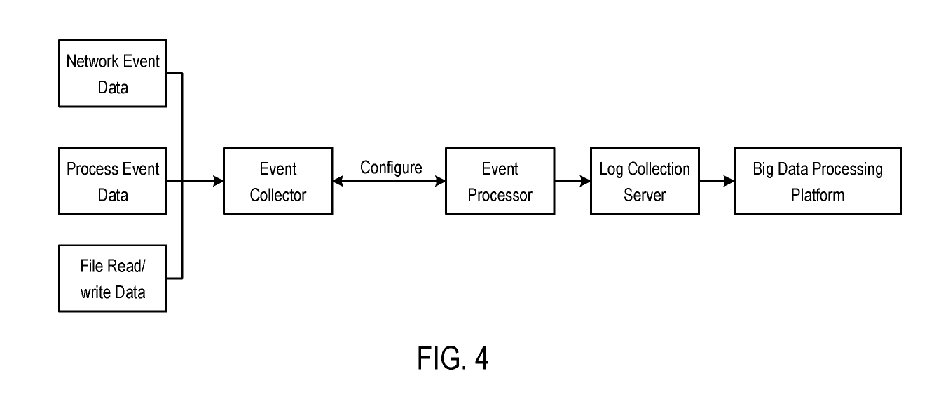

As shown in FIG. 4, the specific implementation process of S301 may include the following steps.

1. Crawling network event data, process event data, and file event data from a lower layer of an operating system through a WINDOWS event collector using an Event Tracing for WINDOWS (ETW) framework or through a LINUX event collector using an Audit framework. To reduce the amount of event data, the granularity of the crawling and the event types are controlled and filtered by an event processor through configuration to exclude known processes, network or file activities involving no risks.

2. The event processor may arrange data into a unified format; and if the current data is not large enough to establish a data flow direction library, the event processor may invoke a system function to complete the data and then upload the data to a log collection server in real time.

3. The log collection server synchronizes the received data in a big data processing platform for storage and waits for further processing after the data buffers reach a certain volume or the data buffer time passes a certain time value.

S302: Write the event data into a network event table, a process event table, and a file read/write event table on the big data processing platform according to the collected data.

Fragment storage may be used for the aforementioned three event tables in accordance with the time dimension.

S303: Respectively establish data flow direction characteristics for each data source characteristic in the following manner: determining a network event relevant to one of the data source characteristics from the network event table; and sequentially obtaining a process using data of the data source and a second network egress through which data of the second data source flows out by using a process number and a timestamp of the network event as search conditions and by associating the network event table, the process event table, and the file read/write event table.

Each data source characteristic can be obtained with manual extraction. Using a TOP data source of e-commerce cloud as an example, an IP address of a TOP server is a fixed list, and a service port is 80.

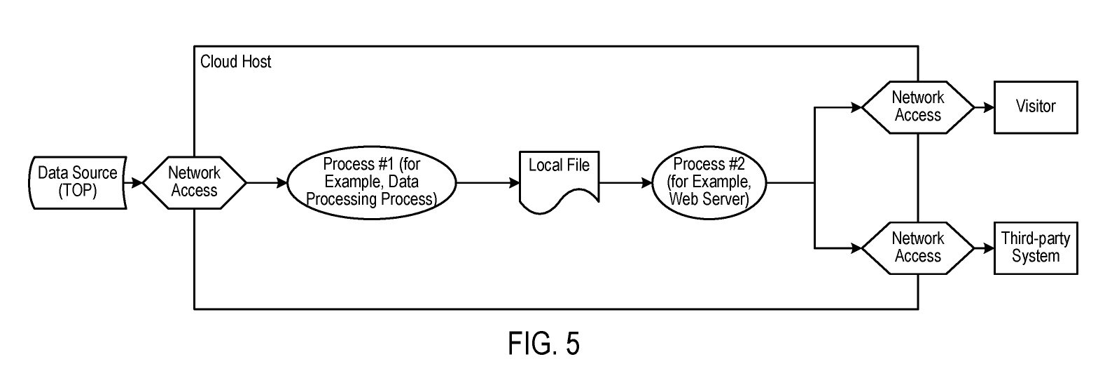

As shown in FIG. 5, data flow direction characteristics of one data source are: data reaches a first process of a cloud host from the data source (for example, TOP in e-commerce cloud) through a network event; and then is stored to a local file through a file write event; and a service process (generally a Web server) reads data through a file read event; and subsequently sends the data to a customer or a third-party system (for example, a logistics system in e-commerce cloud) through a network event. It can be seen that flow direction characteristics of one data source represent a path of data flowing out of this data source in the to-be-detected host.

It should be noted that a file read event is only an intermediate process connecting previous and subsequent processes; and a file read/write event is not regarded as a data flow direction characteristic participating in detecting a suspicious process in the disclosed embodiments.

In this embodiment, an application behavior library is established according to the following steps.

S304: Acquire behavior characteristics of each application from the network event table and the process event table, wherein the behavior characteristics comprise an application level, an access frequency of the application to the data source of the preset type of data, an external connection frequency of the application, an external connection destination address of the application, an external connection port of the application, a user running the application, process command parameters of the application, a running frequency of the application, and a running duration of the application.

It should be noted that the execution order of S303 and S304 can be reversed.

It can be seen from the aforementioned process that the data flow direction library and the application behavior characteristic library are obtained from the scheduled running data of the to-be-detected host; both the data flow direction library and the application behavior characteristic library are therefore featured with up-to-date information. In addition, the data collection process does not affect normal operation of the to-be-detected host.

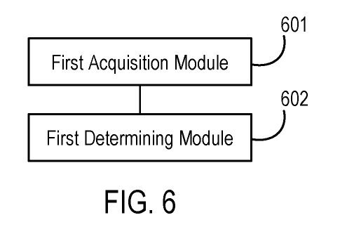

In accordance with the method embodiment shown in FIG. 1, FIG. 6 is a block diagram illustrating a device for detecting a suspicious process according to some embodiments of the disclosure. As shown in FIG. 6, the device includes the following modules.

A first acquisition module 601, configured to acquire test values of data flow direction characteristics of a to-be-detected host, and sample values of the data flow direction characteristics corresponding to the to-be-detected host in a data flow direction library, wherein the data flow direction characteristics comprise at least one of a process list and a network egress characteristic, and a data source characteristic; the data source characteristic is used to indicate a data source of a preset type of data flowing into the to-be-detected host; the process list comprises processes, ranked in chronological order, using data flowing out of the data source; and the network egress characteristic is used to, after the data flowing out of the data source is used by the processes in the process list, indicate an egress for the data flowing out of the data source to flow out of the to-be-detected host.

A first determining module 602, configured to determine that a suspicious process is detected when a test value of the process list is different from a sample value of the process list and/or a test value of the network egress characteristic is different from a sample value of the network egress characteristic in the case that a test value of the data source characteristic is the same as a sample value of the data source characteristic.

The device according to this embodiment uses characteristics of data theft as a starting point; and data flow direction characteristics in a to-be-detected host is used as a basis for performing a suspicious process detection. As a result, a suspicious process of data theft can be accurately discovered.

In accordance with the methods discussed in connection with FIG. 2, one embodiment further discloses another device for detecting a suspicious process.

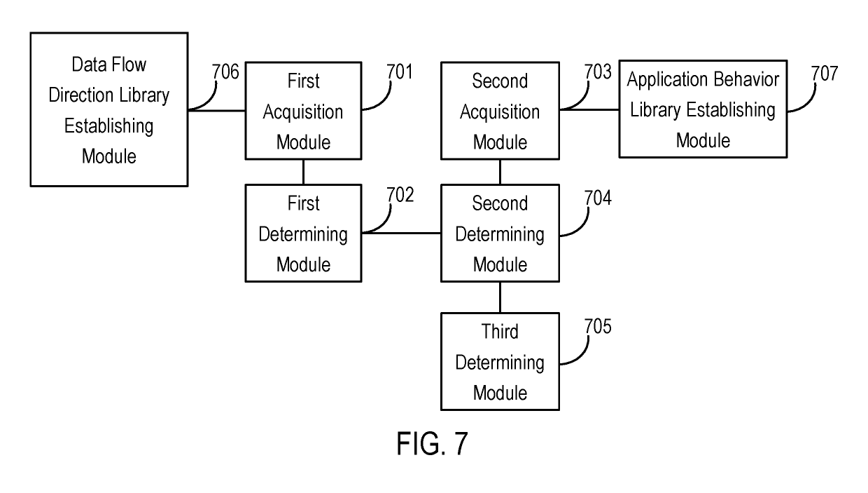

As shown in FIG. 7, a device includes: a first acquisition module 701, a first determining module 702, a second acquisition module 703, a second determining module 704, and a third determining module 705.

Functions of the first acquisition module 701 and the first determining module 702 are the same as, or similar to, those in the previous embodiments, and the disclosure of which is not described herein again but is incorporated by reference in its entirety.

The second acquisition module 703 is configured to acquire test values of behavior characteristics of each application from the to-be-detected host and sample values of the behavior characteristics of the to-be-detected host from an application behavior library, wherein the behavior characteristics comprise at least one of the following: an application level, an access frequency of the application to the data source of the preset type of data, an external connection frequency of the application, an external connection destination address of the application, an external connection port of the application, a user running the application, process command parameters of the application, a running frequency of the application, and a running duration of the application.

The second determining module 704 is configured to determine that a suspicious process is detected if a difference between a test value of any of the behavior characteristics of an application and a sample value of the behavior characteristic of the application in the behavior characteristic library is not within a preset range.

Specifically, the specific process that the second determining module, in the case that any of the behavior characteristics is multidimensional data, determines a difference between a test value of the behavior characteristic and a sample value of the behavior characteristic in the behavior characteristic library may be: calculating a distance value between the test value of the behavior characteristic and the sample value of the behavior characteristic in the behavior characteristic library. The distance value is the difference between the test value of the behavior characteristic and the sample value of the behavior characteristic in the behavior characteristic library.

The third determining module 705 is configured to determine the suspicious process from processes of the to-be-detected host according to preset process risk rules, wherein the process risk rules comprise: the to-be-detected host initiates a network connection to itself and a target port of the connection is a remote login port.

Optionally, the device according to this embodiment may further include a data flow direction library establishing module 706, configured to respectively establish data flow direction characteristics for each data source in the following manner: determining a network event relevant to one of the data source characteristics from a pre-acquired network event table of the to-be-detected host; and sequentially obtaining processes using data of the data source and a second network egress through which data of the second data source flows out by using a process number and a timestamp of the network event as search conditions and by associating the network event table with a process event table of the to-be-detected host and a file read/write event table of the to-be-detected host; and an application behavior library establishing module 707, configured to acquire behavior characteristics of each application from a network event table and process event table of the to-be-detected host that are pre-acquired, wherein the behavior characteristics comprise an application level, an access frequency of the application to the data source of the preset type of data, an external connection frequency of the application, an external connection destination address of the application, an external connection port of the application, a user running the application, process command parameters of the application, a running frequency of the application, and a running duration of the application.

Reference may be made to the methods described in FIG. 3 for the workflow of the data flow direction library establishment module and the application behavior library establishment module.

The device according to this embodiment may be disposed on a data processing platform, such as a big data processing platform of e-commerce. The data processing platform is connected to a to-be-detected host.

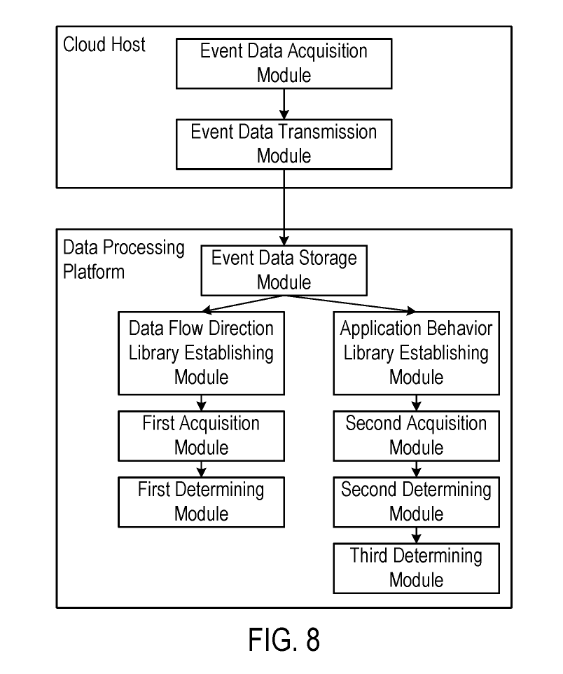

FIG. 8 is a block diagram illustrating a connection relationship between a device for detecting a suspicious process and a to-be-detected host according to some embodiments of the disclosure.

The data processing platform may transmit data in the to-be-detected host to the data processing platform through an existing data collection module and data transmission module; and an event data storage module of the data processing platform may store the data. The device according to this embodiment analyzes and organizes data according to the aforementioned functions; and it detects a suspicious process in the to-be-detected host according to the analysis and organizing result.

It should be noted that the disclosed devices may be disposed in an electronic apparatus; and the electronic apparatus can be a specialized monitoring apparatus; and it can also be a mobile terminal apparatus.

The methods for detecting a suspicious process according to the above embodiment detect a suspicious process from multiple perspectives, thereby providing higher accuracy and shorter delay.

The method functions of this embodiment, when achieved in the form of software function units and sold or used as an independent product, can be stored in a computing device-accessible storage medium. Based on such understanding, part of the disclosed embodiments that make a contribution to the prior art or part of the technical solutions may be embodied in the form of a software product that is stored in a storage medium, including several instructions to enable a computing device (which may be a personal computer, a server, a mobile computing device or a network device, etc.) to execute all or some steps of the methods of various embodiments. The foregoing storage medium can be various media capable of storing program codes, including a USB flash disk, a mobile hard disk, a Read-Only Memory (ROM), a Random-Access Memory (RAM), a disk or a compact disk.

Each embodiment is described in a progressive manner, with each embodiment focusing on parts different from other embodiments, and reference can be made to each other for identical and similar parts among various embodiments.

Those skilled in the art can implement or use the disclosed embodiments through the above descriptions. Various modifications to these embodiments will be apparent to those skilled in the art, and general principles defined in this text may be implemented in other embodiments without departing from the spirit or scope of the disclosure. Therefore, the disclosure will not be limited to these embodiments shown therein, but shall accord with the widest scope consistent with the principles and novel characteristics disclosed by this disclosure.

1-12. (canceled)

13. A method comprising:
acquiring at least one test value of corresponding data flow direction characteristics of a to-be-detected host, the data flow direction characteristics including data source characteristics and a process list associated with the to-be-detected host;
comparing the at least one test value and at least one sample value, the at least one sample value retrieved from a data flow direction library, the at least one sample value being associated with data source characteristics and a process list; and
if the data source characteristics of the test value and of the sample value are the same, and the process lists of the test value and of the sample value are different, determining that a suspicious process is detected.

14. The method of claim 13, wherein the data flow direction characteristics of the at least one test value and at least one sample value further include network egress characteristics of the to-be detected host, wherein the process list comprises processes, ranked in chronological order, using data retrieved from a data source, and wherein the network egress characteristics indicate an egress for the data retrieved from the data source from the to-be-detected host.

15. The method of claim 14, wherein a network egress characteristic comprises an address or port number of network egress.

16. The method of claim 13, further comprising:
retrieving, from an application behavior library, sample values of behavior characteristics of the to-be-detected host;
acquiring test values of corresponding behavior characteristics of each application in the to-be-detected host; and
determining that a suspicious process is detected upon determining that a difference between a test value of any of the corresponding behavior characteristics of an application and a sample value of the behavior characteristics is not within a preset range.

17. The method of claim 16, wherein behavior characteristics comprise at least one of:
an application level,
an access frequency of an application to a data source of the preset type of data,
an external connection frequency of the application,
an external connection destination address of the application,
an external connection port of the application,
a user running the application,
process command parameters of the application,
a running frequency of the application, and
a running duration of the application.

18. The method of claim 16, wherein determining that a determining that a difference between a test value of any of the corresponding behavior characteristics of an application and a sample value of the behavior characteristics is not within a preset range comprises calculating a distance value between the test value of any of the corresponding behavior characteristics of an application and the sample value of the behavior characteristics.

19. The method of claim 16, further comprising identifying the suspicious process from processes of the to-be-detected host according to preset process risk rules.

20. The method of claim 13, further comprising sending a warning signal and adding the suspicious process to a suspicious list of processes.

21. The method of claim 13, further comprising generating the data flow direction library by:
collecting event data in a preset time period by a collection client deployed on the to-be detected host;
writing, based on a type of the event data, the event data into a network event table, a process event table, and a file read/write event table;
selecting a first data source characteristic;
identifying a network event in the network event table relevant to the first data source characteristic;
identifying a process in the process event table the uses data retrieved from a data source associated with the first data source characteristic; and
identifying a network egress through which data retrieved from a data source associated with the first data source characteristic leaves the to-be-detected host.

22. The method of claim 21, wherein the event data comprises data regarding network events, process events, and file read/write events.

23. A device comprising:
a processor; and
a non-transitory memory storing computer-executable instructions therein that, when executed by the processor, cause the device to perform the operations of:
acquiring at least one test value of corresponding data flow direction characteristics of a to-be-detected host, the data flow direction characteristics including data source characteristics and a process list associated with the to-be-detected host;
comparing the at least one test value and at least one sample value, the at least one sample value retrieved from a data flow direction library, the at least one sample value being associated with data source characteristics and a process list; and
if the data source characteristics of the test value and of the sample value are the same, and the process lists of the test value and of the sample value are different, determining that a suspicious process is detected.

24. The device of claim 23, wherein the data flow direction characteristics of the at least one test value and at least one sample value further include network egress characteristics of the to-be detected host, wherein the process list comprises processes, ranked in chronological order, using data retrieved from a data source and wherein the network egress characteristics indicate an egress for the data retrieved from the data source from the to-be-detected host.

25. The device of claim 24, wherein a network egress characteristic comprises an address or port number of network egress.

26. The device of claim 23, wherein the operations further comprise:
retrieving, from an application behavior library, sample values of behavior characteristics of the to-be-detected host;
acquiring test values of corresponding behavior characteristics of each application in the to-be-detected host; and
determining that a suspicious process is detected upon determining that a difference between a test value of any of the corresponding behavior characteristics of an application and a sample value of the behavior characteristics is not within a preset range.

27. The device of claim 26, wherein behavior characteristics comprise at least one of:
an application level,
an access frequency of an application to a data source of the preset type of data,
an external connection frequency of the application,
an external connection destination address of the application,
an external connection port of the application,
a user running the application,
process command parameters of the application,
a running frequency of the application, and
a running duration of the application.

28. The device of claim 26, wherein determining that a determining that a difference between a test value of any of the corresponding behavior characteristics of an application and a sample value of the behavior characteristics is not within a preset range comprises calculating a distance value between the test value of any of the corresponding behavior characteristics of an application and the sample value of the behavior characteristics.

29. The device of claim 26, wherein the operations further comprise identifying the suspicious process from processes of the to-be-detected host according to preset process risk rules.

30. The device of claim 23, wherein the operations further comprise sending a warning signal and adding the suspicious process to a suspicious list of processes.

31. The device of claim 23, wherein the operations further comprise generating the data flow direction library by:
collecting event data in a preset time period by a collection client deployed on the to-be detected host;
writing, based on a type of the event data, the event data into a network event table, a process event table, and a file read/write event table;
selecting a first data source characteristic;
identifying a network event in the network event table relevant to the first data source characteristic;
identifying a process in the process event table the uses data retrieved from a data source associated with the first data source characteristic; and
identifying a network egress through which data retrieved from a data source associated with the first data source characteristic leaves the to-be-detected host.

32. The device of claim 31, wherein the event data comprises data regarding network events, process events, and file read/write events.
